(19) United States
(12) Patent Application Publication
(10) Pub. No.: US 2010/0270363 A1
(43) Pub. Date: Oct. 28, 2010

(54) Controlled Application of Solder Blocks to Establish Solder Connections

(75) Inventors: Tiangfee Yin, Singapore (SG); Larry Moog Martinez, Singapore (SG); PakWing Wong, Singapore (SG); Salim Ahmad, Singapore (SG)

Correspondence Address: Fellers, Snider, Blankenship, Bailey & Tippens, PC;(Seagate Technology LLC), 100 North Broadway, Suite 1700, Oklahoma City, OK, 73102-8820, US

(73) Assignee: SEAGATE TECHNOLOGY LLC, Scotts Valley, CA (US)

(21) Appl. No.: 12/428,779

(22) Filed: Apr. 23, 2009

(51) Int. Cl. B23K 1/20

(52) U.S. Cl. 228/246

(57) ABSTRACT

A method for forming a solder joint to form an electrical interconnection. In accordance with various embodiments, a solid block of solder is placed onto a previously applied layer of solder paste on an underlying electrically conductive pad. The solid block of solder and the layer of solder paste are concurrently reflowed to form a solder joint. In some embodiments, a pick and place machine is used to respectively place the block of solder and a component onto the layer of solder paste, and the hardened solder joint interconnects a terminal of the component to the pad.

### BACKGROUND

Electrical components can be electrically and mechanically connected in various applications, such as to printed circuit boards, through the use of solder. A variety of manual and automated processes for the application of solder, as well as associated solder alloy formulations, are known. While generally operable, most such processes have a number of associated limitations.

Some solder application processes use a stencil to facilitate the selective application of a layer of fluidic solder paste to different locations over an entire circuit board or other member. Such a stenciling procedure can be limited to a certain thickness of the solder paste due to a variety of reasons, such as the characteristic behavior of the solder paste during a reflow process. Thus, stenciling a substantially uniform layer of solder paste may result in some locations having too much solder which can overflow to form an electrical connection to an unwanted part of the circuit board, while other locations may have insufficient solder to establish the desired mechanical and electrical solder joint connections.

### SUMMARY

Various embodiments of the present invention are generally directed to a method for forming a solder joint.

In accordance with various embodiments, a solid block of solder is placed onto a previously applied layer of solder paste on an underlying electrically conductive pad. The solid block of solder and the layer of solder paste are concurrently reflowed to form a solder joint. In some embodiments, a pick and place machine is used to respectively place the block of solder and a component onto the layer of solder paste, and the hardened solder joint interconnects a terminal of the component to the pad.

### BRIEF DESCRIPTION OF THE DRAWINGS

FIG. 1 is an isometric top view of a printed circuit board (PCB) processed in accordance with various embodiments of the present invention.

FIG. 2 shows the PCB of FIG. 1 with the selective application of solder paste thereto.

FIG. 3 shows the PCB of FIG. 2 with the addition of various components.

FIG. 4 illustrates the PCB of FIG. 3 with the further addition of solid blocks of solder.

FIG. 5 shows the PCB of FIG. 4 after a reflow operation.

FIG. 6 shows a portion of the PCB of FIG. 4.

FIG. 7 shows a portion of the PCB of FIG. 5.

FIG. 8 sets forth a flowchart for a routine of selectively applying solder in accordance with various embodiments.

FIG. 9 is a functional diagram for a system that implements the routine of FIG. 8.

### DETAILED DESCRIPTION

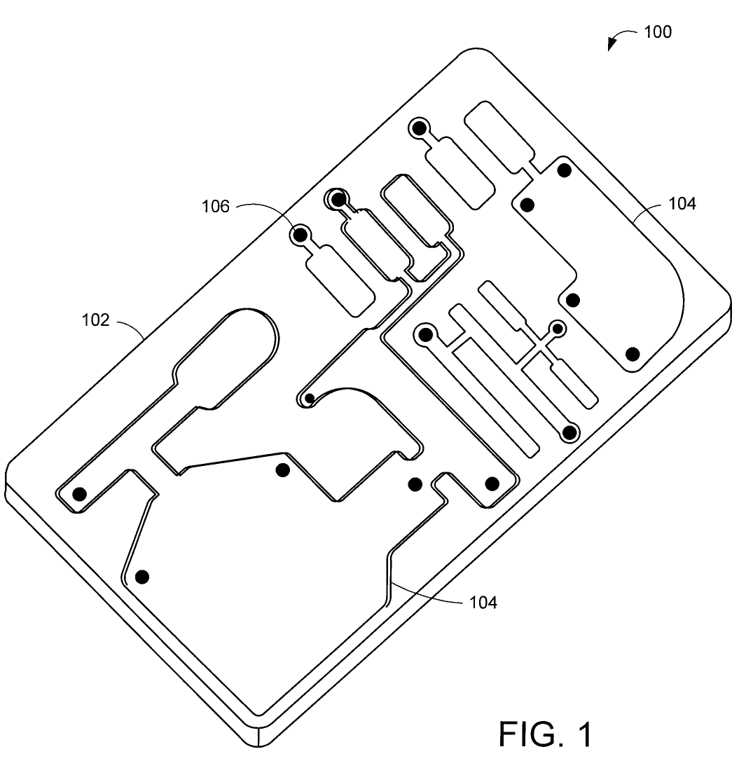

FIGS. 1-5 generally show an isometric top view of an exemplary printed circuit board (PCB) 100 that is successively processed in accordance with various embodiments of the present invention. It will be recognized that various embodiments disclosed herein can be used in a variety of other applications, including applications that do not involve a PCB such as 100.

The PCB 100 as shown in FIG. 1 preferably includes a nonconductive substrate 102 and a number of electrically conductive pads 104. The electrically conductive pads 104 are connected to other layers of electrically conductive material in the substrate 102 through connections 106.

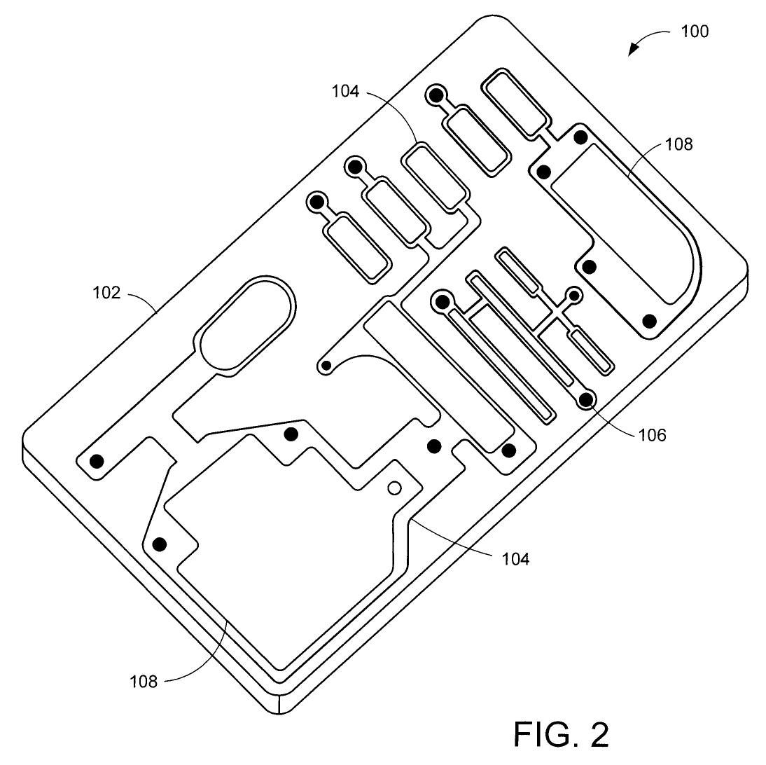

FIG. 2 illustrates the PCB 100 after application of a predetermined amount of fluidic solder paste 108 to selected locations on the electrically conductive pads 104. It is contemplated that the solder paste is applied using a conventional stencil (screen-printing) procedure. As will be recognized by those of skill in the art, such a stencil procedure preferably comprises placing a stencil (not shown) with multiple apertures onto the PCB 100 through which the solder paste 108 passes and subsequently settles in predetermined locations. The stencil thus serves as a mask, to allow the solder paste to be accumulated in localized areas while preventing the solder paste from contacting other areas. However, it is understood that the solder paste 108 can be applied to the electrically conductive pads 104 in various other ways including, but not limited to, manual application and mass wetting.

As will be appreciated, solder paste can take a variety of forms and generally comprises a semi-viscous fluid of constituent materials and/or alloys that, when subsequently heated, reflows to form a hardened solder connection which provides both electrical connectivity and mechanical support. Solder paste formulations can include discrete lead or non-lead based metallic alloy particles suspended in a suitable flux or other carrier/cleaning agent, and provide a flowable viscous fluid that will not harden into a solid shape until sufficient heat is applied to reflow the material.

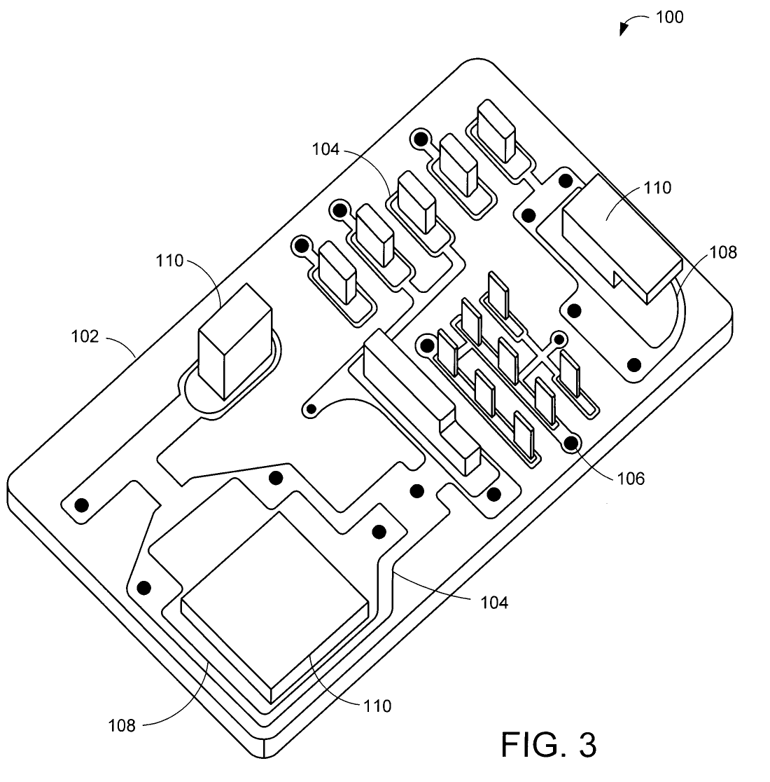

FIG. 3 shows the PCB 100 with the further addition of a number of electrical components 110. The solder paste 108 has a sufficient tackiness to hold the components 110 in place at predetermined locations on the PCB 100. The solder paste 108 temporarily sets the electrical component 110 in place despite movement of the circuit board 100 or exposure to moderately slight external forces. Automated systems, such as pick and place machines, can be used as desired to place the components 110 onto the PCB 100.

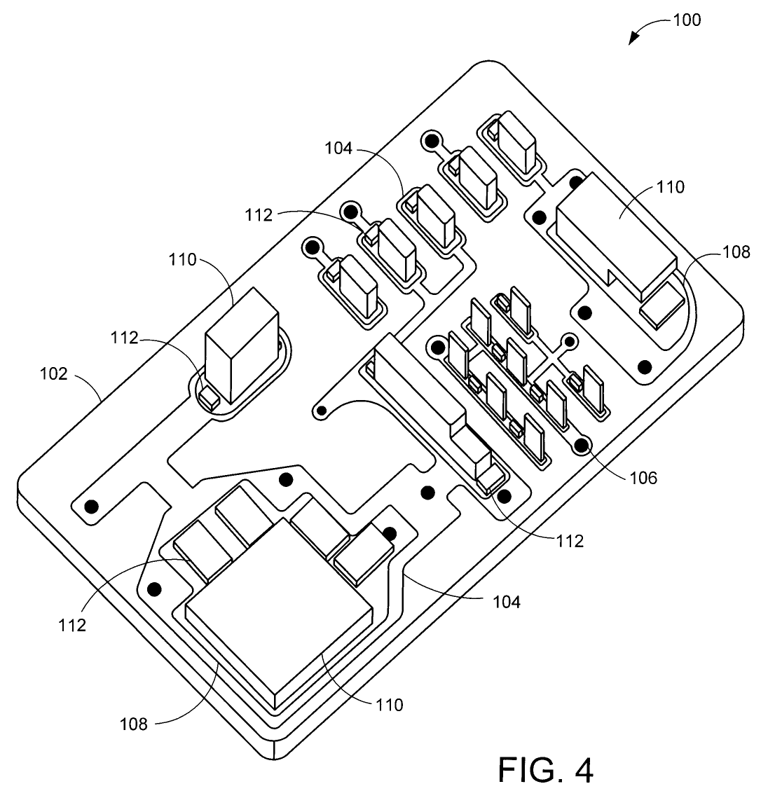

FIG. 4 further shows the PCB 110 with the addition of a number of solid solder blocks 112 (“solder blocks”) to the PCB. The solder blocks 112 can include some of the same constituent materials in the solder paste, but unlike the fluid solder paste, the solder blocks 112 are hardened, rigid blocks that retain their respective shapes during handling and do not flow or change shape until melted. The solder blocks 112 can be formed in a number of suitable ways, such as via an extrusion and cutting process.

While the solder blocks 112 are displayed in rectangular form, the blocks can be formed into various shapes including, but not limited to curvilinear shapes such as spheres, cones or cylinders. The solder blocks 112 are preferably placed near locations where the amount of previously stenciled solder paste 108 is not deemed sufficient to electrically and mechanically connect the electrical component 110 to the conductive pad 104. As few or as many solder blocks 112 can be placed onto the solder paste 108 to better accommodate the formation of secure solder connections. Different sizes of solder blocks 112 can also be utilized at different locations, or even at the same location, as desired.

As before, in a preferred embodiment an automated pick and place machine is employed to place the solder blocks 112 in the desired locations. The solder blocks 112 are also adhered to the circuit board by the solder paste 108 in the same fashion that the components 110 are adhered. Thus, the solder paste 108 serves as an adhesive to “tack” the solder blocks 112 in place.

FIG. 5 shows the PCB 100 after being subjected to a suitable reflow process which concurrently reflows the solder paste 108 and solder blocks 112 to form the desired solder joints (one denoted at 114) on the PCB 100. The reflow process subjects the solder paste and blocks to a sufficient temperature to melt and intermix, and to boil off the various flux or other components that maintained the solder paste in a fluidic form. Preferably during the reflow procedure, the melted solder from the paste 108 and the blocks 112 are liquefied and “sucked in” toward the associated electrical components 110. Upon cooling, the combined mixture of solder paste and solder blocks harden into a solder joint to create a strong electrical and mechanical union via the solder joint (electrical connection layer) 114.

As will be further noted from FIG. 4, solid solder blocks 112 of different sizes, shapes and volumes can be advantageously adhered to different locations on the solder paste 108 suitable for each electrical bond. Likewise, the constituents of the solid solder block 112 can vary to accommodate different electrical connection layer 114 requirements. In some embodiments, the solder paste 108 provides one formulation of alloys and the solder blocks 112 provide a different formulation of alloys, so that the solder joints formed from the combined use of the paste and blocks have a different final metallic constituency as compared to the solder joints formed from the paste alone.

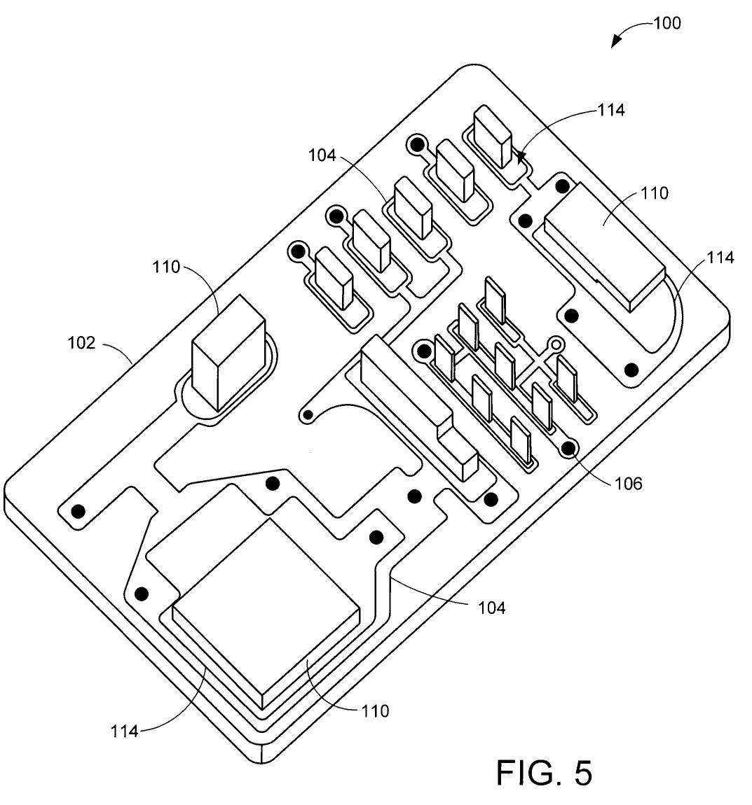

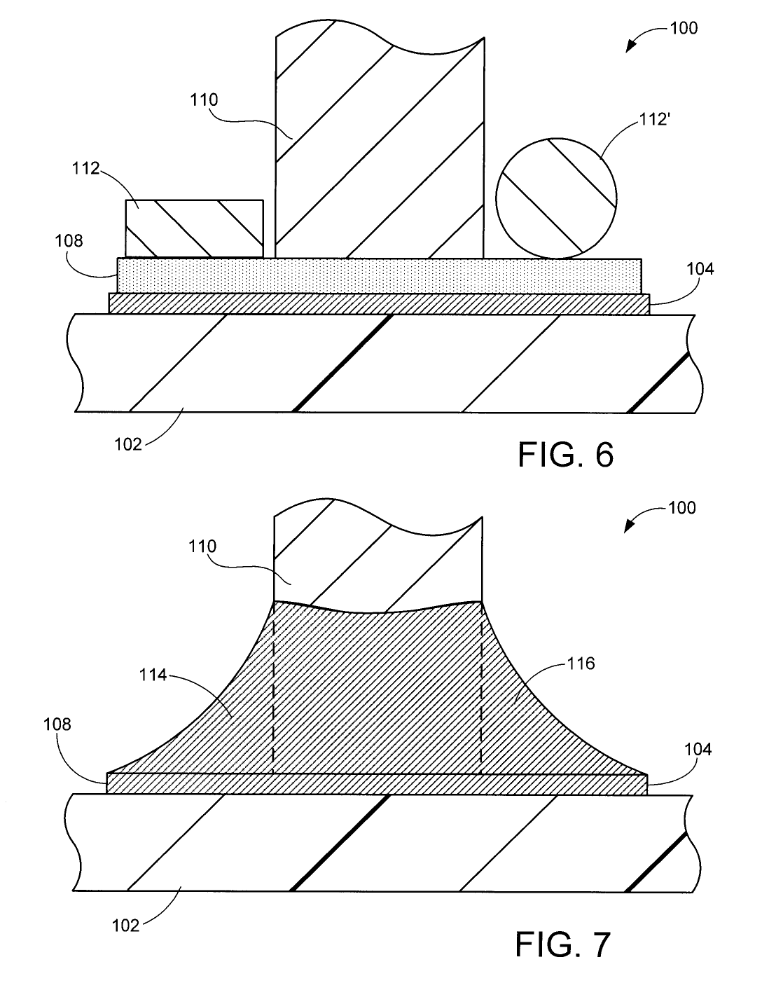

FIG. 6 shows a portion of the PCB 100 corresponding to FIG. 4 (prior to the reflow operation). In FIG. 6, a pair of solder blocks 112, 112′ have been selectively adhered to the solder paste 108 in close proximity to the terminal of the associated electrical component 110. The solder block 112 generally has a rectilinear cross-sectional shape, whereas the solder block 112′ has been provided to illustrate an alternative curvilinear cross-sectional shape. Other arrangements can readily be used, however, depending on the requirements of a given application.

FIG. 7 shows the PCB 100 of FIG. 6 after the reflow operation. As will be noted from FIG. 7, the solder paste 108 and solid solder blocks 112, 112′ from FIG. 6 reflow to form the electrical connection layer 114. The use of the solder blocks 112, 112′ advantageously provide supplemental amounts of solder over and above the solder from the solder paste 108, thereby forming a sufficient fillet 116 that indicates formation of a secure electrical bond for the electrical component 110 to the conductive pad 104 during reflow.

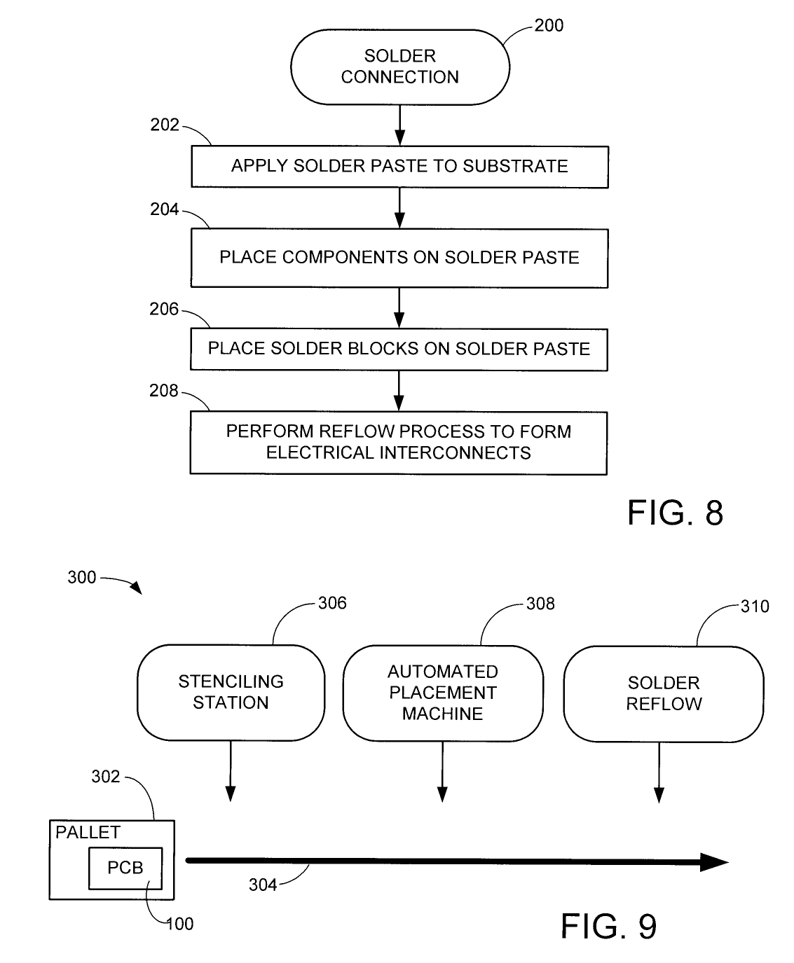

FIG. 8 displays a flowchart for a SOLDER CONNECTION routine 200 to generally illustrate various preferred steps carried out in accordance with the foregoing embodiments. Preferably, a substrate such as the PCB 100 undergoes a solder paste operation at step 202 that distributes a predetermined amount of solder paste to selected locations on conductive pads thereon. This is preferably carried out using a stenciling operation as discussed above so that a desired layer of solder paste is applied to the substrate at each of the respective locations.

At step 204, the substrate is subjected to a component placement operation that places a number of electrical components onto the substrate, preferably by holding the components in place via the applied solder paste in predetermined locations. The component placement operation is preferably carried out using a suitable automated placement (pick and place) machine with suitable component storage, target locating and component dispensing features.

The circuit board preferably subsequently undergoes a solder block placement operation at step 206 that selectively places one or more solid solder blocks in close proximity to the previously placed electrical components on the solder paste. Preferably, step 206 is carried out using the automated placement system of step 204, although a separate placement mechanism can be alternatively used. It will be noted that while the routine lists placement of the solder blocks after placement of the components, such is not limiting; the respective solder blocks could be placed concurrently with, or prior to, the placement of the electrical components. Moreover, it will be appreciated that the solder blocks can be placed at any suitable location where additional solder is required over and above that supplied by the solder paste.

Finally, FIG. 8 shows the substrate is subjected to a reflow operation at step 208. The reflow operation first liquefies (melts) each of the respective solid solder blocks and localized solder paste to form respective volumes of molten solder. Upon subsequent cooling, each localized volume of the molten solder hardens to form an associated electrical solder joint interconnection 114. The reflow operation can take a variety of forms, such as an infrared or similar surface mount system.

FIG. 9 provides an exemplary automated assembly environment 300 generally corresponding to the routine of FIG. 8. The automated assembly environment preferably utilizes a conveyor line 304 along which the PCBs 100 travel via pallets 302. The PCBs 100 are thus sequentially conveyed to a stenciling station 306 for the application of the aforementioned layers of solder paste, to an automated placement machine 308 for the placement of the components 110 and solid blocks of solder 112, and then to a reflow mechanism 310 to reflow the solder and form the desired interconnects. The component placement operation 308 preferably includes at least the use of multiple electrical components that vary in size, shape, and function.

It will now be appreciated that the various embodiments disclosed herein provide the ability to efficiently supplement specific areas where solder paste is insufficient to provide the requisite volume of solder. Although not required, the capability of the solder blocks to be placed using a pick and place machine of the type that also places the components onto the board improves manufacturing efficiencies. The components and solder blocks can be placed concurrently, or in any desired order including different orders at different locations on the board.

Supplementing the solder paste with solder blocks as disclosed herein is more efficient than employing solder mask changeovers to apply different thicknesses of solder paste for different board configurations, or different thicknesses of solder paste to different locations on the same board. The various embodiments thus eliminate the need for secondary paste applications, additive post-reflow soldering operations or variable thickness application systems.

The various embodiments are suitable for use with a wide variety of devices and assemblies including but not limited to printed circuit boards, and particularly applications that have large variances in solder volume requirements from one location to the next. Because solder is electrically conductive, it will be appreciated that a hardened solder joint formed as disclosed herein will constitute an electrical interconnection even if an electrical signal is not actively passed therethrough.

It will be appreciated that the term “pick and place” machines as used herein broadly extends to include any of a wide variety of automated mechanisms used to place components onto a substrate, including various surface mount technologies such as tape and reel platforms to place various surface mount devices onto a circuit board. The ability to utilize a range of surface mount technologies allows integration of selective solder block placement techniques in existing manufacturing lines without the installation of cumbersome or expensive equipment. Further, the compatibility of the solder block placement technology with various existing surface mount technologies expedites the manufacturing of circuit boards.

For purposes of the appended claims, terms such as “solid block of solder” and the like will be defined consistent with the foregoing discussion and in accordance with the plain meaning of the term as understood by the skilled artisan to describe a characteristic of a quantity of solder material arranged as a continuous, solid article configured to retain its shape prior to and until melted through the application of sufficient heat. Such solid blocks of solder will comprise a plurality of metals such as but not limited to tin, lead, etc., and can also include a flux portion therein so long as the solder retains its solid characteristic shape prior to being melted.

Terms such as “solder paste” and the like will be defined consistent with the foregoing discussion and in accordance with the plain meaning of the term as understood by the skilled artisan to describe a fluid made up of a plurality of discrete particles of solder material suspended in a carrier such as a flux or other carrier agent to facilitate application to a substrate via a conventional stenciling or similar process.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising:
placing a solid block of solder onto a previously applied layer of solder paste on an underlying electrically conductive pad; and
concurrently reflowing the solid block of solder and the layer of solder paste to form a solder joint.

2. The method of claim 1, wherein the solder joint electrically and mechanically connects a terminal to the electrically conductive pad.

3. The method of claim 1, wherein the electrically conductive pad is formed on a printed circuit board.

4. The method of claim 1, wherein the solid block of solder comprises a rectilinear cross-sectional shape.

5. The method of claim 1, wherein the solid block of solder comprises a curvilinear cross-sectional shape.

6. The method of claim 1, wherein the concurrently reflowing step comprises applying heat to melt the solid block of solder and the solder paste thereby forming a contiguous volume of molten solder, and then removing said heat to allow the molten solder to cool thereby forming the solder joint.

7. The method of claim 1, further comprising a prior step of using a stencil to apply the solder paste to the electrically conductive pad.

8. The method of claim 7, wherein the solid block of solder is placed onto the layer of solder paste using a pick and place machine.

9. The method of claim 1, wherein the placing and concurrently reflowing steps are carried out as the electrically conductive pad is conveyed along an automated conveyor line.

10. The method of claim 1, wherein the solid block of solder is characterized as a first block, wherein the placing step further comprises placing a second solid block of solder onto the layer of solder paste, and wherein the concurrently reflowing step comprises concurrently reflowing the solder paste and the first and second solid blocks of solder to form the solder joint.

11. The method of claim 10, wherein the second solid block of solder is a different shape than the first solid block of solder.

12. The method of claim 1, further comprising a step of placing an electrical component with an electrical terminal adjacent the electrically conductive pad, wherein the placing the electrical component step occurs after the placing the solid block of solder step and prior to the concurrently reflowing step, and wherein the solder joint electrically and mechanically connects the terminal to the pad.

13. A method comprising:
applying a layer of solder paste to an electrically conductive pad;
placing a terminal of an electrical component onto the layer of solder paste;
placing a solid block of solder onto the layer of solder paste; and
concurrently reflowing the solder paste and the solid block of solder to form a solder joint that electrically connects the terminal to the pad.

14. The method of claim 13, wherein the electrically conductive pad is formed on a printed circuit board.

15. The method of claim 13, wherein the solid block of solder comprises a rectilinear cross-sectional shape.

16. The method of claim 13, wherein the solid block of solder comprises a curvilinear cross-sectional shape.

17. The method of claim 13, wherein the solder paste is applied to the electrically conductive pad with a stencil.

18. The method of claim 13, wherein the placing steps are carried out using an automated placement machine which respectively places the component and the solid block of solder adjacent the pad.

19. The method of claim 13, wherein the applying, placing and concurrently reflowing steps are carried out as the electrically conductive pad is conveyed along an automated conveyor line.

20. The method of claim 13, wherein the solid block of solder is characterized as a first block, wherein the placing the solid block of solder step further comprises placing a second solid block of solder adjacent the solder paste, and wherein the concurrently reflowing step comprises concurrently reflowing the solder paste and the first and second solid blocks of solder to form a solder joint.
